(19) United States
(12) Patent Application Publication
(10) Pub. No.: US 2007/0222640 A1
(43) Pub. Date: Sep. 27, 2007

(54) Portable hazard marker with sensing and communications systems

(76) Inventors: Thomas Kent Guelzow II, Eau Claire, WI (US); Kurt J. Fenske, Gleason, WI (US); Michael J. Buchmann, Chippewa Falls, WI (US)

Correspondence Address: Erick G. Swenson;Merchant & Gould P.C.,, P.O. Box 2903, Minneapolis, MN, 55402-0903, US

(21) Appl. No.: 11/376,692

(22) Filed: Mar. 14, 2006

(51) Int. Cl. G08G 1/095; G08B 1/08

(52) U.S. Cl. 340/908; 340/539.13

(57) ABSTRACT

A portable communications unit is disclosed. The portable communications unit includes a portable hazard marker that forms a housing. The portable communications unit also includes a wireless receiver/transmitter within the housing, and control circuitry interfaced with the wireless receiver/transmitter. The portable communications unit also includes an electrical energy storage unit electrically connected to the wireless receiver/transmitter and the control circuitry. A plurality of portable communications units can be placed at an emergency site to facilitate communication between emergency responders.

### GOVERNMENT LICENSE RIGHTS

The U.S. Government has a paid-up license in this invention and the right in limited circumstances to require the patent owner to license others on reasonable terms as provided for by the terms of Contract No. W15P7T-05-C-P2235 awarded by CERDEC/S&TCD of Fort Monmouth, N.J., an organizational member of the U.S. Army.

### TECHNICAL FIELD

The present invention is directed generally to sensing and communications systems. In particular, the present invention is related to a sensing and communications unit housed within a portable device.

### BACKGROUND

Fires, explosions, and other catastrophic events require the action of trained first responders and other emergency responders, including the police department, fire department, and appropriate medical responders. Particularly during large, catastrophic events individuals from multiple organizations are involved in the emergency response effort. In such situations, coordination of these groups and individuals, alongside crowd control, are important to providing a prompt and effective response.

Communication among emergency responders requires a portable communications system that can quickly and reliably extend to any location at which an emergency might arise. Such communications systems are used by emergency responders to coordinate response efforts and to determine the status of the emergency personnel as well as the status of the other response personnel. Existing communications systems generally consist of radio-to-radio communication, which requires voice confirmation of the status of first responders and direct radio-to-radio reception. Because of this, it is not possible to determine whether personnel are out of range or are otherwise incapacitated. Additionally, situations exist in which emergency responders cannot easily see or speak with each other because of the need to maintain silence or because of bad wireless reception. Furthermore, the range of such radio networks are limited by the broadcast range of the single source of the communication, which presents a range limitation most prevalent and problematic in the case of large-scale emergency response efforts. For example, 900 MHz and 2.4 GHz communications generally are limited to a quarter mile to a half mile range from the point at which transmission takes place. These signals attenuate much more quickly and therefore can only travel much shorter distances when penetrating walls or encountering other interference sources.

For these and other reasons, improvements are desirable.

### SUMMARY

In accordance with the present disclosure, the above and other problems are solved by the following:

In one aspect of the disclosure, a portable communications unit is disclosed. The portable communications unit includes a portable hazard marker that forms a housing. The portable communications unit also includes a wireless receiver/transmitter within the housing, and control circuitry interfaced with the wireless receiver/transmitter. The portable communications unit also includes an electrical energy storage unit electrically connected to the wireless receiver/transmitter and the control circuitry.

In another aspect of the present disclosure, a mesh network is disclosed. The mesh network includes a plurality of portable communications units. Each portable communications unit includes a stackable emergency cone forming a housing, a wireless receiver/transmitter within the housing, a printed circuit board located within the housing and containing control circuitry interfaced with the wireless receiver/transmitter, and an electrical energy storage device located proximate to the housing and electrically connected to the wireless receiver/transmitter and the control circuitry.

In yet another aspect of the present disclosure, a method of facilitating communication at an emergency site between emergency responders is disclosed. The method includes configuring a plurality of portable communications units to send and receive wireless communications between themselves and to one or more wireless interpersonal communication devices. The method also includes sending communications signals from a first emergency responder to a second emergency responder, the communications signals relayed by at least one of the plurality of portable communications units.

In another aspect of the present disclosure, a method of communicating at an emergency site is disclosed. The method includes deploying at least one emergency responders to the emergency site, the at least one emergency responder equipped with a personal communications device. The method also includes deploying at least one portable communications unit at a location near the emergency site. The method further includes communicating with the at least one emergency responders via communications signals relayed by the at least one portable communications unit to the personal communications device.

### BRIEF DESCRIPTION OF THE DRAWINGS

FIG. 1 is a block diagram of a communications network according to a possible embodiment of the present disclosure;

FIG. 2 is a diagram of a mesh network according to a possible embodiment of the present disclosure;

FIG. 3 is a block diagram of a portable sensing and communications system according to a possible embodiment of the present disclosure;

FIG. 4 is a top level block diagram of a portable communications unit according to a possible embodiment of the present disclosure;

FIG. 5 is a block diagram of the control circuitry according to a possible embodiment of the present disclosure; and

FIG. 6 is a flowchart illustrating a system of facilitating communication at an emergency site between emergency responders according to a possible embodiment of the present disclosure.

### DETAILED DESCRIPTION

In the following description of preferred embodiments, reference is made to the accompanying drawings that form a part hereof, and in which is shown by way of illustration specific embodiments in which the invention can be practiced. It is understood that other embodiments can be utilized and changes can be made without departing from the scope of the present invention.

In general, the present disclosure describes a portable communications unit, a mesh network formed from a plurality of portable communications units, and a method of forming such a network. More specifically, the present disclosure is related to a portable marker incorporating communications and sensing systems, and capable of interconnecting with similar devices to form a portable communications network using one or more communications frequencies and/or protocols.

The portable communications unit, according to the present disclosure, includes a portable hazard marker forming a housing. Preferably, the housing holds a wireless receiver/transmitter, control circuitry, and an electrical energy storage unit. The housing can also include a global positioning system unit, one or more sensors, a beacon, and a video camera. The portable communications unit can be controlled via a remote control. The unit can also include an external power source, such as a direct current or alternating current power source.

The present disclosure further describes a mesh network. Mesh networks incorporate a plurality of single nodes capable of sending and receiving voice or data communications. In such networks, wireless communications are routed from the node initially receiving data through any number of communicatively connected nodes to a destination. If multiple nodes exist in communicative connection to the source node, multiple potential transmission paths exist. Once a second node receives the data from a source node, that node can then send that data to any nodes to which it is communicatively connected. In this way, voice and data communications can travel from a source to a destination without requiring direct communicative contact between those two nodes. Furthermore, mesh networks add redundancy and increase potential throughput as additional nodes are added. Therefore, such mesh networks provide a reliable data and voice communications platform when a large number of nodes are placed in communicative proximity to each other.

Mesh nodes can be implemented as stationary devices to extend, for example, 802.11 networks in urban areas and other areas of consistent high population density where there is a known demand for access to a wireless communication point. However, emergency sites are inherently unpredictable, and do not necessarily have preexisting access to a wireless communications network or a known or potentially anticipated communications protocol. The present disclosure contemplates both extension of existing communications networks as well as establishing a separate communications network in areas inaccessible to existing networks.

Preferably, the mesh network can include a one or more portable communications units. Each portable communications unit includes a stackable emergency cone forming a housing, a wireless receiver/transmitter located within the housing, at least one sensor, and a printed circuit board located within the housing and containing control circuitry interfaced with the wireless receiver/transmitter and the sensor. The mesh network can also include an electrical energy storage unit, such as a battery, that is located within the housing and is electrically connected to the control circuitry and the wireless receiver/transmitter. It can also include a global positioning system unit. It can further include one or more personal communications devices connected to the portable communications units. The communication frequency of the wireless receiver/transmitter can be in the range of about 400 MHz to about 5 GHz. The mesh network can further include a video camera, an external power input, and a remote control.

The present disclosure further describes a method of facilitating communication at an emergency site between emergency responders. The method involves configuring portable communications units to send and receive wireless communications between themselves and to one or more wireless interpersonal communication devices. The portable communications units are configured as a portable hazard marker and including at least one sensor, a wireless receiver/transmitter unit, and an electrical energy storage unit. The method further includes deploying at least one of the portable communications units near the emergency site. The method further involves sending communications signals from a first emergency responder to a second emergency responder such that the communications signal is relayed by at least one of the portable communications units.

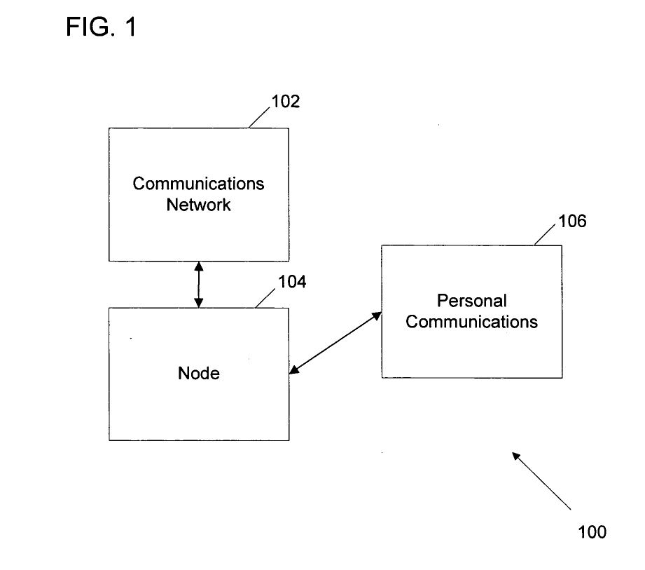

Referring to FIG. 1, FIG. 1 is a block diagram of a communications system 100. Preferably, the communication system 100 can include a communication network 102, at least one node 104, and at least one personal communication device 106. The at least one node 104 is portable and can establish an interface to allow communication between the at least one communication device 106 and the communications network 102.

Typically, the communications system 100 would include a plurality of nodes 104 and personal communication devices 106 such that a plurality of personnel can communicate with each other and communicate remotely through the communicating network. Such communications can include voice and data.

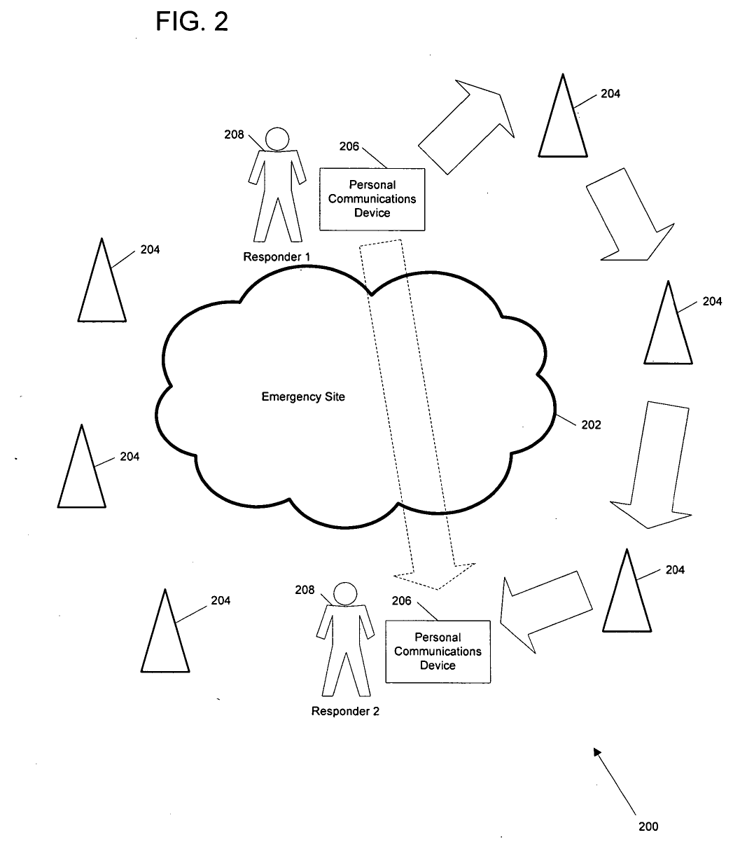

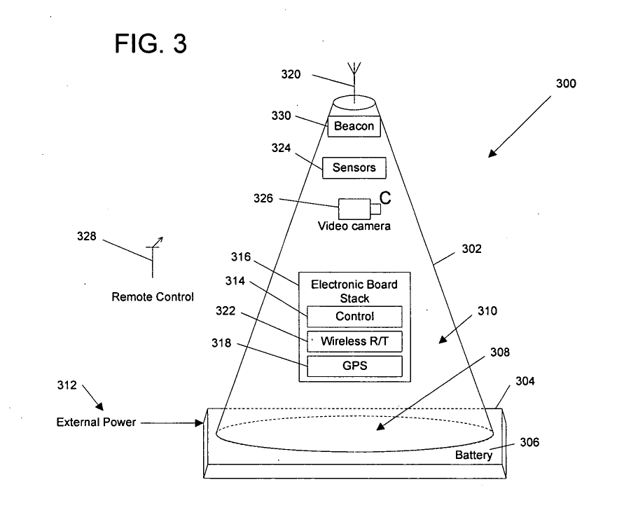

Referring now to FIG. 2, a diagram of a mesh network 200 is shown according to a possible embodiment of the present disclosure. The mesh network 200 is established at an emergency site 202. Preferably, the mesh network 200 includes a plurality of communications units 204, such as the one described below in conjunction with FIG. 3. The portable communications units 204 can be distributed nearby to, or proximate to, or within, the emergency site 202 in a variety of different configurations. In the example shown in FIG. 2, the portable communications units 204 surround the emergency site 202.

The mesh network 200 can include one or more personal communications devices 206. The personal communications devices 206 can be personal radios, cellular communication devices, or other communications devices such as radio or packet-based communications devices. The personal communication devices 206 are communicatively connected to the portable communications units 204 in the mesh network 200. The personal communications devices 206 and portable communications units 204 share at least one of any number of communications formats, such as 900 MHz, 2.4 GHz, 802.11, or other suitable communications format.

Each portable communications unit 204 acts as a mesh node in the mesh network 200. Preferably, the mesh network 200 is decentralized, relatively inexpensive, and very reliable and resilient. The portable communications units 204 only need to transmit as far as the next node. The portable communications units 204 act as repeaters, transmitting data from nearby nodes to peers that are too far away to reach. This results in a mesh network 200 that can span large distances over unfriendly terrain, such as the emergency site 202. The mesh network 200 can also provide redundancy, as each portable communications unit 204 is connected to several other units that are also acting as nodes. If one node drops out of the network, due to hardware failure, battery life or any other reason, the neighboring units 204 find another route. Extra network capacity can be installed by simply introducing additional portable communications units 204. The units 204 in the mesh network 200 will only connect with other devices that are in a set range; hence, bandwidth increases as more units 204 become available, provided that the number of hops in the average communications path is kept to a minimum.

The personal communication devices 206 can be, for example, in the possession of one or more emergency responders 208 at the emergency site 202. The emergency responders 208 can send data wirelessly using the personal communications devices 206. Data sent by the emergency responders 208 can include personal vital sign data, voice or text communications, sensor output, alarm conditions, or other data. The data is transmitted using the common communications format shared by the personal communications device 206 and the portable communications units 204.

The portable communications units 204 can relay the data among the units (an example path of which is shown by the solid arrows of FIG. 2) such that the data can be received by the desired recipient, such as another emergency responder 208 having a personal communications device 206 or a control station (not shown). Data will hop from one device to another until it reaches a given destination. This is enabled by dynamic routing capabilities provided in each unit 204. To implement such dynamic routing capabilities, each unit 204 communicates its routing information to every device to which it connects. Each unit 204 determines what to do with the data it receives—either pass it on to the next device or keep it. A variety of routing algorithms can be used to determine the route a message should take from a source to a destination among the portable communications units 204. The routing algorithm used should attempt to always ensure that the data takes the most appropriate, or fastest, route to its destination.

This multi-hop data transmission allows the emergency responders 208 to communicate when direct wireless transmission between the personal communications devices 206 is not possible due to interference or signal attenuation (an example of which is shown by the dashed arrow of FIG. 2).

Referring now to FIG. 3, a top level diagram of a portable communications unit 300 is shown according to a possible embodiment of the present disclosure. The portable communications unit 300 incorporates a portable hazard marker 302 forming a housing. This portable hazard marker 302 can be, for example, of conical or frustoconical shape and can resemble an emergency cone, as shown by the housing of FIG. 3. Of course, any suitable shape or size could be used.

Portable hazard markers 302 are available in many varieties. For example, emergency cones, also known as traffic cones, road cones, safety cones, or pylons, are generally brightly colored plastic or rubber cones used on roads and around hazardous areas for diverting traffic or warning passersby of dangerous conditions at construction or accident sites. Such cones fall within the category of portable hazard markers, which are movable indicators of potentially hazardous conditions that can be used by police, firefighters, or other emergency responders to demarcate an emergency area for safety or crowd control reasons. Emergency cones or traffic cones are often used, but many types of these markers are used in establishing barriers in situations where emergency responders are called. Furthermore, such markers can exist in a variety of colors and non-conical shapes and are not limited to the shapes of existing markers. Traffic cones and other portable hazard markers come in many different colors, with orange, yellow and red being the most common colors due to their high visibility. They can also have a reflective strip ringing the cone or cylinder shape of the hazard marker to further increase their visibility.

Portable hazard markers are, for example, frequently used in indoor public spaces to mark off areas that are closed to pedestrians, such as an out of order restroom or sidewalk; or to make note of a dangerous condition, such as a slippery floor.

Portable hazard markers 302 are generally easy to move or remove. Where sturdier (and larger) markers are needed, traffic barrels (plastic orange barrels with reflective stripes, normally about the same size as a 55 gallon drum) can be used, and can be weighted with sandbags for additional stability. These drums also are considered portable hazard markers. However, the size, shape, and color of the portable hazard marker 302 can be varied as appropriate.

The portable hazard marker 302 as shown has a base 304. Preferably, the base 304 includes an electrical energy storage device 306. In an alternate embodiment (not shown), the electrical energy storage device is not incorporated into the base of the housing. In such an embodiment, the electrical energy storage device can either be incorporated within the interior volume of the housing or can reside external to the housing.

In the frustoconical embodiment shown, the portable hazard marker 302 is at least partially hollow and forms an opening 308 in the base 304. The portable hazard marker 302 is stackable, in that a top portion of a first marker fits through the opening 308 in the base 304 of another portable hazard marker 302, and is capable of at least partially residing within an internal volume 310 of the second marker. Of course, other housing shapes are possible consistent with the present disclosure that would also allow for stacking of two or more portable communications units 300. The units do not necessarily need to be hollow or conical to be stackable.

The portable hazard marker 302 also includes an external power input 312 allowing the portable communications unit 300 to be powered by an external power source. The external power source can be, for example, either an alternating current (AC) or direct current (DC) power source. In the embodiment shown, the external power input 312 is located in the base 304. However, the external power input 312 can be located elsewhere on the housing consistent with the present disclosure.

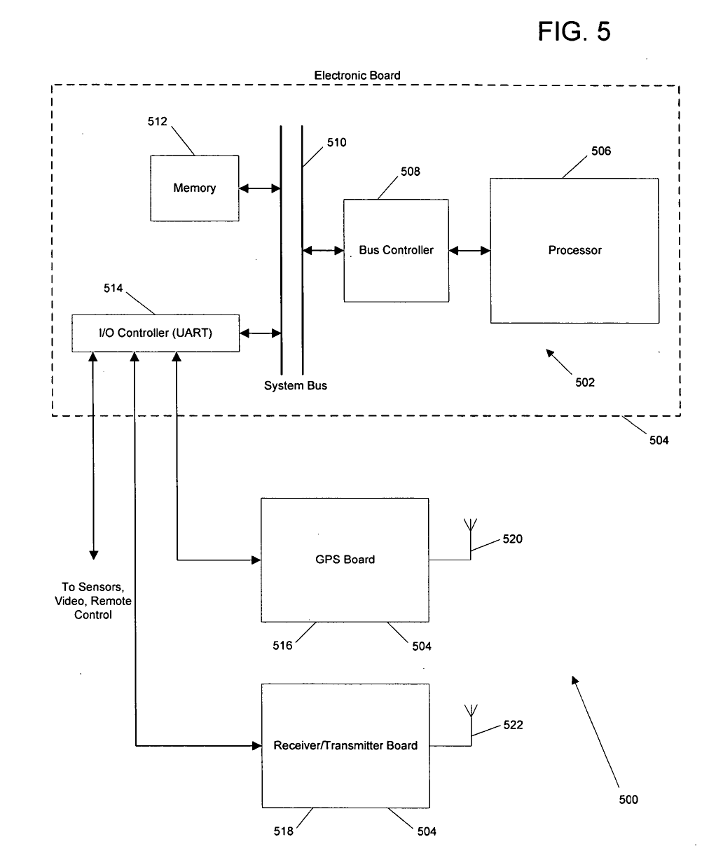

Preferably, the portable hazard marker 302 contains control circuitry 314. The control circuitry 314 is powered by either the electrical energy storage device 306 or an external power source via the external power input 312. The control circuitry 314 can be included in a small form factor package, such as a Small Board Computer (SBC) printed circuit board assembly 316. Of course, other small form factor layouts and other control circuitry components could be used consistent with the present disclosure. The control circuitry 314 is discussed in more depth in conjunction with FIG. 5, below.

The portable hazard marker 302 can also contain a global positioning system (GPS) receiver unit 318. The GPS receiver unit 318 can determine its own location by communication with a GPS satellite system. If the GPS receiver unit 318 operates on a public network such as a cellular telephone network or is connected to the Internet, it can also use positional information based on what cellular telephone tower or IP address provider it is in communication with. The GPS receiver unit 318 can, for example, be incorporated with the control circuitry 314 in a small form factor SBC board system 316. Such a system could be used in direct conjunction with control circuitry on a circuit board of a similar form factor, as described in more detail below in conjunction with FIG. 5. The GPS receiver unit 318 can incorporate an antenna or connection to an antenna such as the antenna 320 shown in FIG. 3.

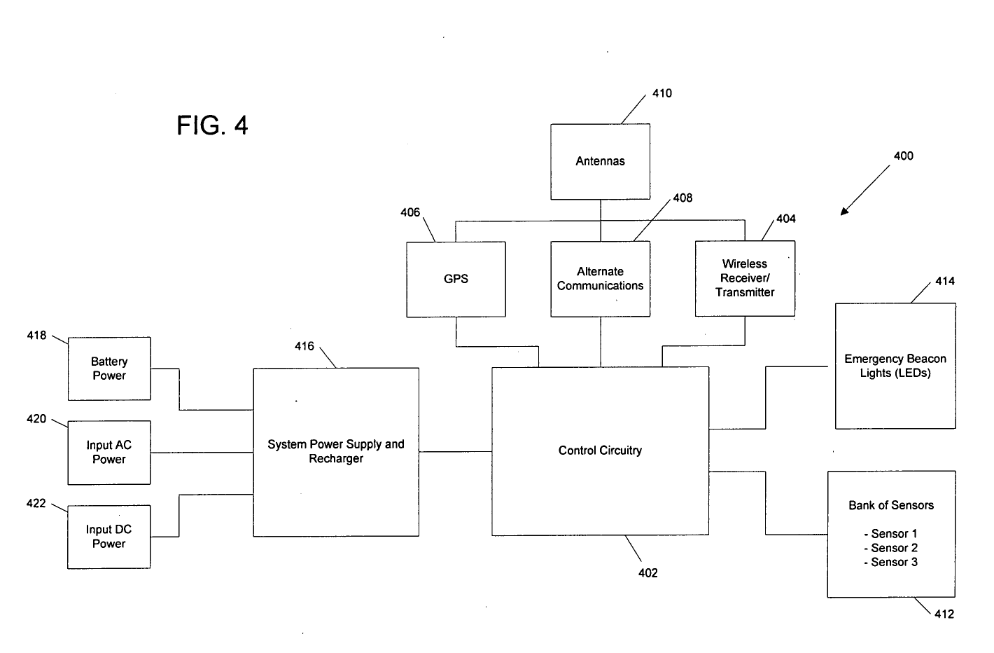

Preferably, the portable hazard marker 302 further contains a wireless receiver/transmitter 322 operatively connected to the control circuitry 314. The wireless receiver/transmitter 322 can be, for example, a packet-based network using a standard protocol such as 802.1a/b/g, or other proprietary voice or data communications protocol. The wireless receiver/transmitter 322 is described in more detail below in conjunction with FIG. 4.

The portable hazard marker 302 can contain at least one sensor 324. The sensor 324 can be any of a number of sensors, depending upon the specific anticipated use of the portable communications unit. For example, a fire station could choose to incorporate a smoke sensor, a temperature sensor, or a motion sensor into the units that would then be deployed at the site of a fire. The units 300 could then transmit information detected by these sensors to a central control location where firefighting is coordinated. The motion sensor is able to determine if any firefighters or other persons are near the portable communications unit and therefore in proximity to the fire. The coordinating personnel at the central control location can then be aware of the location of individuals who are close to the fire, the temperature of the air near the fire, and whether smoke is still detected at various locations around the fire without requiring radio contact to a firefighter. Of course, additional or different sensors could be incorporated in the portable communications unit 300 consistent with the present disclosure. Additional sensors are described below in conjunction with FIG. 4.

The portable communications unit 300 can contain a video camera 326. The video camera 326 can be any of a number of compact video cameras, and can either include onboard memory or be enabled to stream video images through use of the wireless receiver/transmitter 322, as controlled by the control circuitry 314.

Preferably, the portable hazard marker 302 incorporates one or more antennas 320 for the system components requiring external communication. Specifically, the wireless receiver/transmitter 322 can incorporate one or more antennas for communication over one or more frequencies at once. Also, the GPS receiver unit 318 includes an antenna, and can or can not incorporate one with the GPS circuitry. Therefore, a separate GPS communication antenna can be incorporated.

Additional antennas allow added functionality to the portable communications unit. For example, a dedicated RF antenna can be used in conjunction with a remote control 328 to enable or disable specific functions within the unit. Or, additional antennas can allow for concurrent broadcast of data over multiple frequencies using multiple communications protocols. Preferably, the antennas 320 are located near the top of the unit 300 for best reception.

The portable communications unit 300 can further include a beacon 330. The beacon 330 is preferably located at or near the top of the portable hazard marker 302, and preferably is a low power luminous device. For example, the beacon 330 can include one or more light emitting diodes (LEDs) or xenon flashers.

Referring now to FIG. 4, a block diagram of a portable communications unit 400 is shown according to a possible embodiment of the present disclosure. Preferably, control circuitry 402 is incorporated into the portable communications unit 400. The control circuitry 402 can, for example, be an embedded computing system including a processor, memory, and communicative input/output devices as described in conjunction with FIG. 5, below.

Preferably, a wireless receiver/transmitter 404 is operatively connected to the control circuitry 402. The wireless receiver/transmitter 404 can be, as described above, a standard protocol packet-based network such as 802.11a/b/g, or other proprietary voice or data communications protocol. The wireless receiver/transmitter 404 is programmable and can be configured to communicate with other such devices to form a mesh network such as described above in conjunction with FIG. 2. As such, each wireless receiver/transmitter 404 cooperates with the control circuitry 402 to act as a mesh node in the mesh network.

The wireless receiver/transmitter 404 preferably operates within the UHF and SHF bands, more specifically at frequencies between about 400 MHz and about 5 GHz. For example, the wireless receiver/transmitter 404 can operate based on a standard 900 MHz or 2.4 GHz signal. Alternately, the wireless receiver/transmitter 404 could incorporate packet-based wireless technology and could, for example, be an 802.11a/b/g mini PCI card added to the SBC board (as shown in FIG. 5) containing the control circuitry 402. The wireless receiver/transmitter 404 could also operate based on a cellular telephone protocol, such as GSM 850/900/1800/1900 MHz, CDMA, W-CDMA or other equivalent network.

Use of a standardized communication protocol can be advantageous in that a wide variety of easily integrable components can be used as the wireless receiver/transmitter according to the present disclosure. Further, it is easily recognized that the wireless receiver/transmitter 404 could be configured to operate in a different frequency band outside of the UHF or SHF frequencies consistent with the principles described herein.

A global positioning system (GPS) receiver 406 can be operatively connected to the control circuitry 402. The global positioning system receiver 406 can be, for example, a global positioning system receiver/antenna unit configured on a SBC board system, available from any of a number of embedded systems manufacturers.

Additionally, the portable communications unit 400 can incorporate alternate communications systems 408. The alternate communications systems 408 can allow the portable communications unit 400 to establish communicative connections external to the mesh network described above.

Preferably, the portable communications unit 400 includes one or more antennas 410. The antennas 410 facilitate signal transmission and detection for the GPS receiver 406, the wireless receiver/transmitter 404, and the alternate communications systems 408. The one or more antennas 410 can be included in the portable communications unit 400, although it is preferable that multiple antennas are incorporated into the unit to facilitate simultaneous wireless connectivity of each of the wireless receiver/transmitter 406, GPS receiver 408, and alternate communications systems 410.

A wide variety of sensors 412 can be connected to the control circuitry 402. One or more sensors can be incorporated in the portable communications unit 400, depending upon the exact form factor of the portable hazard marker housing. Of course, external sensors could also be connected. The sensors 412 can include a temperature sensor, a smoke sensor, a motion sensor, a vibration sensor, an accelerometer, a radiation sensor, a gas sensor, a chemical sensor, a biological material sensor, or other suitable sensor.

The temperature sensor can be a noncontact temperature sensor. A noncontact temperature sensor can measure the thermal radiant power of the Infrared or Optical radiation that it receives from a known or calculated area on its surface, or a known or calculated volume within it (in those cases where the object is semitransparent within the measuring wavelength passband of the sensor).

The smoke sensor can be, for example, an ionizing sensor or a photoelectric sensor. Ionizing smoke detectors use an ionization chamber and a source of ionizing radiation to detect smoke. They consist of two plates with a voltage across them, and a source of ionizing radiation, causing a current. When smoke enters the ionization chamber it disrupts this current by neutralizing the ions. The smoke detector senses the drop in current between the plates and sets off the alarm. Photoelectric smoke detectors incorporate a light source and a sensor. In the normal case, the light from the light source misses the sensor. When smoke enters the chamber, the smoke particles are scattered by the smoke and some amount of light hits the sensor. The sensor then sets off the alarm.

The motion sensor detects motion of persons, such as emergency responders, near the portable communications unit. The motion sensor can be, for example, a passive system that detects infrared energy. In order for a sensor to detect a human being, the sensor must be sensitive to the temperature of a human body. Humans radiate infrared energy with a wavelength between 9 and 10 micrometers based on skin temperature. Therefore, the motion sensor is typically sensitive in the range of 8 to 12 micrometers. The sensor therefore will not detect colder objects (e.g. cars, etc.) or warmer objects (e.g. fire), based on their respective emitted radiation wavelengths.

The vibration sensor detects vibration of the portable communications unit, and can have from one axis to three axes of measurement, the multiple axes orthogonal to each other. The vibration sensor can, for example, be any one of a piezoelectric, capacitance, null-balance, strain gage, resonance beam, piezoresistive, magnetic induction type sensor, or other suitable vibration sensor.

The accelerometer can incorporate one or more gyroscopes to determine the change in rate of movement of the body of the portable communications unit 400. The accelerometer can incorporate, for example, a deflectable mechanical device and deflection-sensing circuitry.

The radiation sensor is designed to detect and measure any of a number of specific types or energies of nuclear or ionizing radiation. The sensor will rely on one or more sensing mechanisms and produce a signal that indicates the nuclear/ionizing radiation value. The sensor can include a fiber optic sensor, a low background detector, or a personal dosimetry sensor.

The gas sensor can be any of a number of commercially-produced gas sensors designed to detect toxic, flammable, or asphyxiating gases. Typically, such sensors are variable resistance sensors that will therefore allow a variable current to pass through the sensing circuit when a given voltage is applied. A current detection circuit can be used in conjunction with the chosen gas sensor to determine the relative levels of gas present.

The chemical sensor can be any of a number of sensors designed to detect the presence or absence of a specific ion. Likewise, the biological sensor can be any of a number of commercial sensors designed to detect the presence or absence of specific biological material.

Each type of sensor 412 produces an electrical signal that can be evaluated by the control circuitry 402 and communicated between one or more portable communications units 400 and therefore about a mesh network. Often, such sensors 412 employ a variable resistor or switching activity in which electrical flow within a circuit is altered depending upon the presence or absence of the property to be sensed.

Electrical signals from the sensors 412 can be converted to numerical values and transmitted as data using the wireless receiver/transmitter 404 to one or more emergency responders. In this way, emergency responders can determine and monitor the conditions near an emergency site at many remote points near the site. Additionally, similar sensors can accompany the emergency responders and be communicated to the portable communications units 400, allowing other emergency responders to remotely monitor each other's status when within range of the mesh network.

Preferably, the portable communications unit 400 incorporates a beacon 414 operatively connected to the control circuitry 402. The beacon 414 is operatively connected to the control circuitry, which selectively provides an electrical signal to flow to the beacon causing it to illuminate.

Preferably, the portable communications unit 400 incorporates a system power supply 416. The power supply 416 is electrically connected to the control circuitry 402 and provides the connection to at least one energy source. The power supply shown incorporates connections to a battery 418, alternating current (AC) power 420, and direct current (DC) power 422. The power supply 416 can also include a charger to charge the battery 418.

The battery 418 can be, for example, a high-capacity battery such as a lithium-ion battery or other similar capacity rechargeable or replaceable battery system. The battery 418 provides for a relatively long period of operation, as it has a high storage capacity relative to the power consumption needs of the electronic components of the portable communications unit 400. In a possible embodiment, a rechargeable battery provides 4-16 hours of continuous operation of the portable communications unit 400 depending upon configuration of the unit. In such an embodiment, the battery 418 retains a sufficient charge so that the unit 400 can intermittently activate, sense, and communicate information wirelessly and last well over a month on a single charge. The AC power 420 can be, for example, a standard 110V/220V input voltage source such as from an electrical outlet. The DC power 422 can be any of a number of predetermined voltages.

The power supply 416 acts as a voltage regulator and rectifier providing the control circuitry with a constant, regulated source of energy for powering the portable communications unit 400. For example, the power supply 416 can provide a constant 3.3 V source signal for powering the assorted electronic components described herein.

Referring now to FIG. 5, a block diagram of the control circuitry 502 of the portable communications unit 500 is shown according to a possible embodiment of the present disclosure. In the embodiment shown, the control circuitry 502 resides on one or more SBC sized circuit boards 504. Embedded computing systems in a SBC layout are roughly the same dimensions as a computer diskette (e.g. 3.5″-4″ square), or smaller and have connection pins for connecting the basic embedded components (processor, memory, and I/O) to additional functional blocks that can also be on SBC circuit boards. Each board 504 has 104 connectivity pins and operates using the Industry Standard Architecture (ISA) bus specification.

In the embodiment shown, one SBC board 504 includes a processor 506, a bus controller 508, a system bus 510, a memory 512, and an input/output controller 514. The processor 506 can be any of a number of central processing units manufactured by, for example, Intel, Advanced Micro Devices, Via Technologies, or Transmeta Corporation. Preferably, a low power, embedded central processing unit is used in which extensive heat dissipation is not required. The system bus 510 connects one or more data handling components such as the memory to the processor by way of the bus controller. The bus controller 508 arbitrates and monitors traffic on the system bus 510 and provides a controlled, single-source data conduit to the processor 506.

The system bus 510 is connected to the memory 512, which preferably includes a flash memory, or other non-volatile memory, usable in low power applications. The memory 512 can also include a read only memory (ROM) and random access memory (RAM). The read only memory can hold, for example, the basic input/output system (BIOS), containing the basic routines that help transfer information between elements within the control circuitry 502 such as during start up.

A number of program modules can be stored in the memory 512, including a kernel or other embedded operating system, one or more application programs and other modules or program data. User input, by way of a remote control, for example, can control operation of the control circuitry 502 and therefore change the function of the portable communications unit 500.

The system bus 510 is also connected to the input/output controller 514, which handles data communications external to the SBC board 504. In the embodiment shown, the input/output controller 514 is a universal asynchronous receiver-transmitter (UART). In the embodiment shown, the input/output controller 514 manages the handshaking protocols specified by the bus architectures communication protocol, enabling the bidirectional data flow from the main control SBC board 504 to the other parts of the portable communication device 500. Other boards and components in the portable communication device 500 can have associated with them complementary input/output controllers 514 for managing the complimentary handshaking operations necessary to enable bidirectional communication. Alternately or in conjunction with the bidirectional handshaking operation, the input/output controller 514 could periodically poll various devices to determine if action is necessary with respect to the polled device (e.g. a sensor, the GPS system, or the wireless receiver/transmitter).

The battery system, as described above in conjunction with FIG. 3, can provide 4-16 hours of continuous operation, depending upon the components included in the unit. This may not provide sufficient duration in situations where the portable communications unit 500 is in place for an extended period of time, such as a month or more. In such cases, the control circuitry 502 can contain one or more software programs residing in memory 512. These programs can include low-level scheduler software that can change the state of the unit 500 between a usage mode and an idle mode. By using a higher power usage mode and a lower power idle mode, the battery life of a portable communications unit 500 can be extended such that each unit must only be charged monthly, rather than multiple times daily.

One of skill in the art will recognize that the portable communications unit 500 could also incorporate hardware and software to support remote mode switching between idle and operative states, such as by a remote control, wake on LAN (wirelessly), or other such signal. For example, 802.11 wake on LAN is supported by a number of current 802.11-based chips made by companies such as ORiNOCO and Agere Systems.

One or more units placed in proximity can be scheduled to change to an active state based on time period or received signal, and then send such a signal to activate other portable communications units within that vicinity as well.

One of skill in the art will further appreciate that the disclosure might be practiced with other computer system configurations or in distributed computing environments where software execution and data sharing occurs between multiple portable communications units 500. In such a distributed environment, program modules can be located in both local and remote memory storage devices.

The control circuitry 502 can be connected to one or more additional printed circuit boards or integrated circuit systems, such as SBC boards 504 containing a GPS receiver 516 and a wireless receiver/transmitter 418. These components are operatively connected to one or more antennas 520, 522, respectively, or can share an antenna.

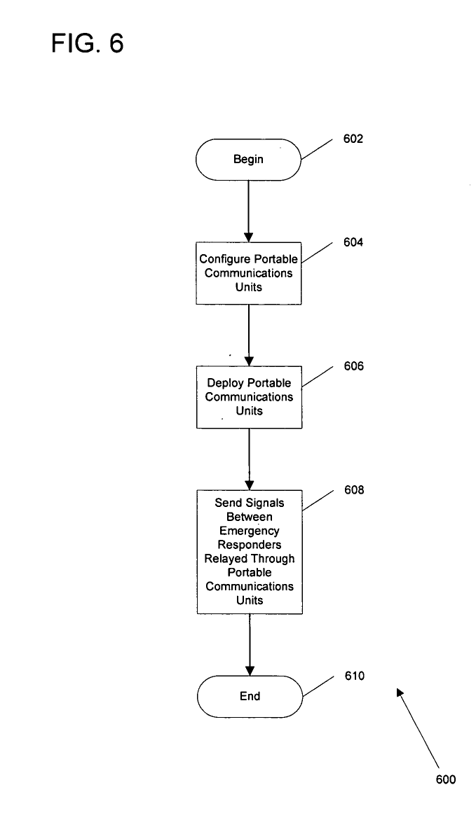

Referring now to FIG. 6, a flowchart is shown illustrating a system 600 of facilitating communication at an emergency site between emergency responders according to a possible aspect of the present invention.

The system 600 includes a begin operation 602.

The system 600 incorporates a configure module 604 for configuring at least one portable communications unit to send and receive wireless communications between itself and to one or more wireless interpersonal communication devices. The portable communications units are configured as portable devices, such as shown in conjunction with FIG. 3. Preferably, the portable communications units include at least one sensor, a wireless receiver/transmitter unit, and an electrical energy storage unit, as previously described. A plurality of portable communications units form a mesh network for relaying communications between the units and, for example, between two or more emergency responders at the emergency site. For example, the portable communications units can be configured to form a 900 MHz mesh network or a 802.11 mesh network.

The system 600 also includes a deploy module 606 for deploying at least one of the plurality of portable communications units proximate to the emergency site. The deploying can be accomplished manually by one or more persons. In an example embodiment, one or more emergency responders deploy the portable communications units at multiple locations at least partially surrounding the emergency site.

The system 600 further includes a send module 608 that sends communications signals from a first emergency responder to a second emergency responder. The send module relays the communications signals through at least one of the plurality of portable communications units. Communications signals can also be relayed to a command and control station (not shown) that can communicate with other first responders via the system 600.

One of skill in the art will recognize that a particular order of modules of the system 600 is not required. In one possible embodiment, the portable communications units self-configure after deployment to the emergency site. In another possible embodiment, the units are configured before deployment.

Through use of the one or more of the portable communications units consistent with the system described herein, the two or more emergency responders can communicate without having direct radio communication access to each other. This is accomplished by relaying communications signals through one or more of the portable communications units described herein.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A portable communications unit comprising:
(a) a portable hazard marker forming a housing;
(b) a wireless receiver/transmitter located within the housing;
(c) control circuitry interfaced with the wireless receiver/transmitter; and
(d) an electrical energy storage unit electrically connected to the wireless receiver/transmitter and the control circuitry.

2. The portable communications unit of claim 1, wherein the housing is at least partially hollow.

3. The portable communications unit of claim 2, wherein the portable communications unit is stackable with a second portable communications unit.

4. The portable communications unit of claim 1, wherein the portable hazard marker is a traffic cone.

5. The portable communications unit of claim 1, wherein the unit operates as a mesh node for a mesh network.

6. The portable communications unit of claim 1, further comprising a global positioning system unit.

7. The portable communications unit of claim 1, further comprising a remote control.

8. The portable communications unit of claim 1, further comprising at least one emergency beacon powered by the electrical energy storage unit.

9. The portable communications unit of claim 8, wherein the emergency beacon includes a light emitting diode.

10. The portable communications unit of claim 8, wherein the emergency beacon includes a xenon flasher.

11. The portable communications unit of claim 1, wherein the wireless receiver/transmitter is operable on multiple communication frequencies.

12. The portable communications unit of claim 1, further comprising at least one sensor located within the housing and interfaced with the control circuitry.

13. The portable communications unit of claim 12, wherein the at least one sensor is a temperature sensor.

14. The portable communications unit of claim 12, wherein the at least one sensor is a smoke sensor.

15. The portable communications unit of claim 12, wherein the at least one sensor is a motion sensor.

16. The portable communications unit of claim 12, wherein the at least one sensor is a radiation sensor.

17. The portable communications unit of claim 12, wherein the at least one sensor is a vibration sensor.

18. The portable communications unit of claim 12, wherein the at least one sensor is a gas sensor.

19. The portable communications unit of claim 12, wherein the at least one sensor is a chemical sensor.

20. The portable communications unit of claim 12, wherein the at least one sensor is a biological sensor.

21. The portable communications unit of claim 1, further comprising an external power input.

22. The portable communications unit of claim 1, wherein the external power input accommodates an alternating current input.

23. The portable communications unit of claim 1, wherein the external power input accommodates a direct current input.

24. The portable communications unit of claim 1, wherein the electrical energy storage unit is a rechargeable battery.

25. The portable communications unit of claim 1, wherein the electrical energy storage unit is incorporated in the housing.

26. The portable communications unit of claim 1, further comprising a video camera.

27. A mesh network for communications comprising:
a plurality of portable communications units, each portable communications unit comprising:
(a) a hazard marker forming a housing;
(b) a wireless receiver/transmitter located within the housing;
(c) a printed circuit board located within the housing and containing control circuitry interfaced with the wireless receiver/transmitter; and
(d) an electrical energy storage unit located proximate to the housing and electrically connected to the wireless receiver/transmitter and the control circuitry;
whereby communications between emergency responders is facilitated.

28. The mesh network of claim 27, wherein each portable communications unit further comprises at least one sensor located within the housing and interfaced with the control circuitry.

29. The mesh network of claim 27, wherein each portable communications unit further comprises an electrical energy storage unit located within the housing and electrically connected to the wireless receiver/transmitter and the control circuitry.

30. The mesh network of claim 27, wherein each portable communications unit further comprises a global positioning system unit interfaced with the control circuitry.

31. The mesh network node unit of claim 27, further comprising one or more personal communications devices communicatively connected to the plurality of portable communications units.

32. The mesh network of claim 27, wherein the wireless receiver/transmitter is configured to communicate at multiple frequencies in the range of about 400 MHz to about 5 GHz.

33. The mesh network of claim 27, wherein the portable communications units include a video camera.

34. The mesh network of claim 27, wherein the portable communications units include an external power input.

35. The mesh network of claim 27, wherein the portable communications units include a remote control.

36. A method of facilitating communication at an emergency site between emergency responders comprising:
configuring at least one portable communications unit to send and receive wireless communications within a network and to one or more wireless interpersonal communication devices, the at least one portable communications unit having a portable hazard marker housing and including a wireless receiver/transmitter unit and an electrical energy storage unit; and
sending communications signals from a first emergency responder to a second emergency responder, the communications signals relayed by the at least one portable communications unit.

37. The method of claim 36, wherein the configuring step further comprises configuring the portable communications units to form a mesh network.

38. The method of claim 36, wherein the configuring step further comprises configuring the portable communications units to form a packet-based mesh network.

39. The method of claim 36, further comprising establishing the at least one portable communications units at a location near the emergency site.

40. The method of claim 39, wherein the establishing step comprises establishing a plurality of portable communications units at one or more locations at least partially surrounding the emergency site.

41. A method of communicating at an emergency site comprising:
deploying at least one emergency responders to the emergency site, the at least one emergency responder equipped with a personal communications device;
deploying at least one portable communications unit at a location near the emergency site;
communicating with the at least one emergency responders via communications signals relayed by the at least one portable communications unit to the personal communications device.

42. The method of claim 41, wherein the communicating with the at least one emergency responder includes communicating between at least two personal communications devices and through the at least one portable communications unit.

43. The method of claim 41, wherein the deploying includes deploying at least one portable communications unit having a portable hazard marker housing and including a wireless receiver/transmitter unit and an electrical energy storage unit.
